(19) United States
(12) Patent Application Publication
(10) Pub. No.: US 2008/0264998 A1
(43) Pub. Date: Oct. 30, 2008

(54) Nail positioning device for nailers

(75) Inventor: Yi-Kuan Lee, Ta-Li City (TW)

Correspondence Address: CHARLES E. BAXLEY, ESQUIRE, 90 JOHN STREET, SUITE 309, NEW YORK, NY, 10038, US

(73) Assignee: Samson Power Tool Co., Ltd.

(21) Appl. No.: 11/796,393

(22) Filed: Apr. 27, 2007

(51) Int. Cl. B25C 3/00

(52) U.S. Cl. 227/107

(57) ABSTRACT

A nose assembly of a nailer includes a mounting member mounted onto a base unit so as to define a path therebetween. A magazine is connected to the base unit and nails are pushed into the path via a slot defined in the base unit. A recess is defined in the mounting member and a magnet is received in the recess so as to attract the nail in the path. The magnet positions the nail of different lengths in the path so that the nails can be ejected correctly.

### FIELD OF THE INVENTION

The present invention relates to a nail positioning device which position the nail in the path of the nose assembly of a nailer so as to be correctly pushed by the pushing rod.

### BACKGROUND OF THE INVENTION

The conventional nose assemblies for nailers includes two different types, one of which includes a circular or D-shaped path which is cooperated with nails with circular head or D-shaped head. The nails are connected to each other by plastic-made or paper-made connection pieces. The other type of the nose assembly includes a flat path which is cooperated with headless nails or I-shaped head nails. The nails are connected to each other by glue so that the shanks of nails are closely connected to each other. The headless or I-shaped nails are pushed by a flat section of a pushing plate in the magazine so that the long nails can easily positioned in the path and ready to shoot. However, when using short nails, the flat section cannot firmly position the nail in the path so that the other section that has an inclined surface of the pushing plate is used to position the nail in the path. This often makes the short nail orients an angle in the path so that the short nail cannot be ejected out from the nose assembly as desired. Sometimes the last short nail drops from the path because it is not well positioned by the pushing plate.

The present invention intends to provide a nail positioning device that uses a magnet which is located at a proper position of the path so as to attract the nail to ensure that the nail is positioned as expected in the path of the nose assembly.

### SUMMARY OF THE INVENTION

The present invention relates to a nose assembly of a nailer and the nose assembly is connected to the barrel and comprises a mounting member a base unit. The mounting member is fixed to the base unit and a magazine is connected to the base unit. A path is defined between the mounting member and the base unit so as to receive nails therein. A slot is defined through the base unit and communicates with the path and the magazine. A recess is defined in the mounting member and a magnet is received in the recess so as to attract a nail in the path.

The primary object of the present invention is to provide a nose assembly of a nailer wherein a magnet is connected to the mounting member so as to position the nail of different lengths in the path.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the mounting member and the base unit of the nose assembly of the present invention;

FIG. 2 is a cross sectional view to show a nail is positioned in the path by the magnet in the mounting member, and

FIG. 3 is a cross sectional view to show the nail in the path is pushed by a pushing rod.

### DETAILED DESCRIPTION OF THE PREFERRED EMBODIMENT

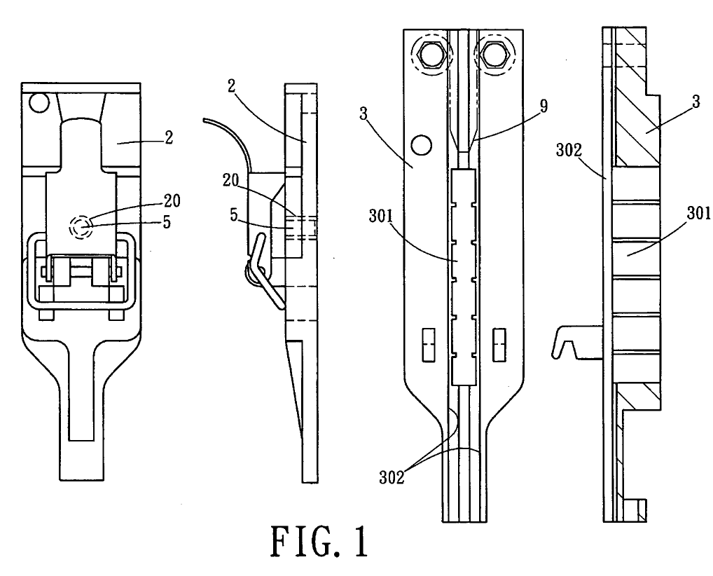

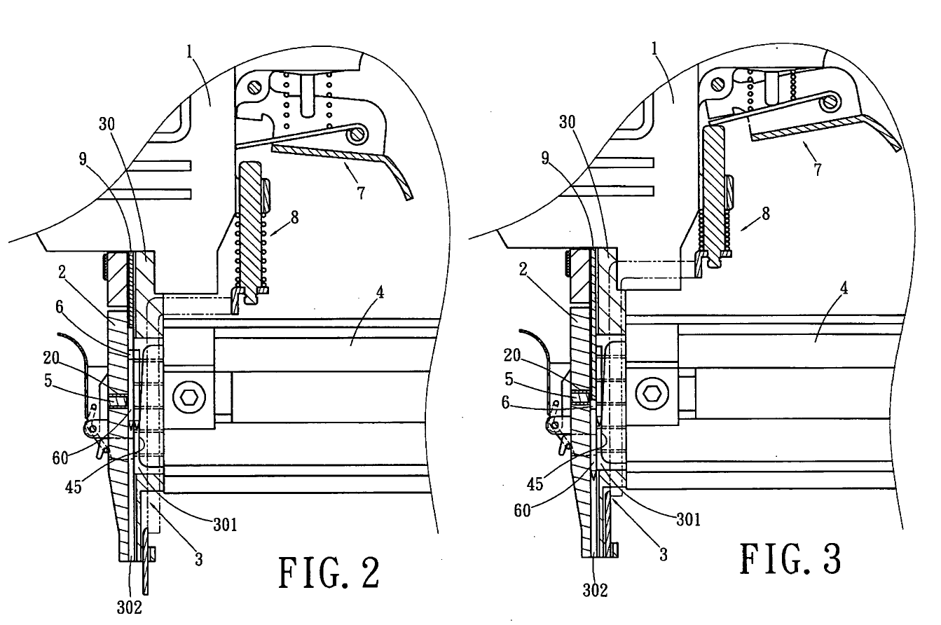

Referring to FIGS. 1 and 2, the nose assembly of a nailer is connected to the barrel 1 and comprises a mounting member 2 and a base unit 3. The mounting member 2 is fixed to the base unit 3 and a magazine 4 is connected to the base unit 3. The base unit 3 can be a single board 30 or composed of two pieces which are not shown. A path 302 is defined between the mounting member 2 and the base unit 3. A slot 301 is defined through the base unit 3 and communicates with the path 302 and the magazine 4 so that nails 6 received in the magazine 4 can be pushed into the path 302 via the slot 301 by a pushing plate 45 in the magazine 4. A recess 20 is defined in the mounting member 2 and located from an end of the slot 301 at least ⅓ of a total length of the slot 301. A magnet 5 is received in the recess 20 so as to attract the nail 6 in the path 302.

It is noted that the magnet 5 can be any known assembly or arrange that attracts the nail 6. The specific position of the magnet 5 ensures that a shank 60 of a short nail 6 is attracted as shown in FIG. 2. When one end of the safety link 8 is pushed against an object to be nailed, the other end of the safety link 8 pushes an activation plate of the trigger assembly 7 toward the valve on the handle of the nailer. When the user pulls the trigger assembly 7, the pressurized enters into the barrel 1 and moves the pushing rod 9 to eject the nail 6 in the path 302. Because the nail 6 is well positioned in the path 302 so that the nail 6 is correctly nailed into the object.

While we have shown and described the embodiment in accordance with the present invention, it should be clear to those skilled in the art that further embodiments may be made without departing from the scope of the present invention.

What is claimed is:

1. A nose assembly of a nailer which includes a barrel with a trigger assembly connected to a handle, a safety link movably connected to the nose assembly and an end of the safety link located beside the trigger assembly, a pushing rod movably inserted into the nose assembly, the nose assembly connected to the barrel and comprising:
a path defined therethrough and a slot defined through the nose and communicating with the path, the slot being adapted to communicate with the magazine, a recess defined in the nose and a magnet received in the recess so as to attract a nail in the path, the recess located from an end of the slot at least ⅓ of a total length of the slot.

2. The nose assembly as claimed in claim 1, wherein the nose is composed of a mounting member and a base unit, the mounting member is fixed to the base unit which has the slot defined therethrough and is adapted to be connected to the magazine, the path defined between the mounting member and the base unit.

3. The device as claimed in claim 1, wherein the base unit includes a single board.
